(19) United States
(12) Patent Application Publication
(10) Pub. No.: US 2017/0064084 A1
(43) Pub. Date: Mar. 2, 2017

(54) Method and Apparatus for Implementing Voice Mailbox

(71) Applicant: Huawei Technologies Co., Ltd., Shenzhen (CN)

(72) Inventor: Chaoyue Zhang, Shenzhen (CN)

(21) Appl. No.: 15/350,328

(22) Filed: Nov. 14, 2016

Related U.S. Application Data
(63) Continuation of application No. PCT/CN2014/095101, filed on Dec. 26, 2014.

(30) Foreign Application Priority Data
May 15, 2014 (CN) 201410206720.3

(51) Int. Cl. H04M 3/533; H04M 1/64

(52) U.S. Cl. CPC H04M 3/533; H04M 1/645

(57) ABSTRACT

A method and an apparatus for implementing a voice mailbox is presented, including receiving a call request that is from a first terminal and whose destination address is a second terminal; sending a call response to the first terminal based on the call request, where the call response is used to instruct a user of the first terminal to leave a voice message; receiving a voice message that is sent by the first terminal after the call response is received; recognizing words in the voice message, to convert the voice message into a word text; and performing, according to the word text, a reply operation with respect to the first terminal or a notification operation with respect to the second terminal.

### CROSS-REFERENCE TO RELATED APPLICATIONS

This application is a continuation of International Application No. PCT/CN2014/095101, filed on Dec. 26, 2014, which claims priority to Chinese Patent Application No. 201410206720.3, filed on May 15, 2014, both of which are hereby incorporated by reference in their entireties.

### TECHNICAL FIELD

The present application relates to the communications field, and in particular, to a method and an apparatus for implementing a voice mailbox.

### BACKGROUND

The emergence of voice mailboxes is based on a scenario in which a telephone user or a mobile phone user cannot answer a call. In this case, the incoming call enters a voice mailbox, and the user may explain in the voice mailbox that he or she cannot answer the call and a caller may leave a message under instruction of a voice prompt. After that, the user may check the voice message left by the caller.

A conventional voice mailbox mainly relies on a telecommunication operator. A call is transferred to a voice mailbox of a user, a prompt is given according to a pre-recorded speech, and a message left by a caller is recorded to facilitate check of the user.

In recent years, as smartphones become popular, another type of voice mailbox existing on smartphones has emerged. This type of voice mailbox does not rely on an operator any more. A corresponding application is installed on an intelligent terminal to implement a voice mailbox, and a voice message left by a caller is recorded to facilitate check of a user.

However, both the foregoing operator-based voice mailbox and voice mailbox that is implemented by relying on an intelligent terminal record only a voice message to obtain a recorded file to facilitate check of a user. The function is single and does not have a characteristic of being “intelligent”.

### SUMMARY

Embodiments of the present application provide a method and an apparatus for implementing a voice mailbox, which can make a function of a voice mailbox stronger and more intelligent.

According to a first aspect, a method for implementing a voice mailbox is provided, including receiving a call request that is from a first terminal and whose destination address is a second terminal; sending a call response to the first terminal based on the call request, where the call response is used to instruct a user of the first terminal to leave a voice message; receiving a voice message that is sent by the first terminal after the call response is received; recognizing words in the voice message, to convert the voice message into a word text; and performing, according to the word text, a reply operation with respect to the first terminal or a notification operation with respect to the second terminal.

With reference to the first aspect, in a first possible implementation manner of the first aspect, the performing, according to the word text, a reply operation with respect to the first terminal or a notification operation with respect to the second terminal includes performing natural language processing (NLP) on the word text, to determine a matching field of the word text; and performing, according to the matching field of the word text, the reply operation with respect to the first terminal or the notification operation with respect to the second terminal.

With reference to the first possible implementation manner of the first aspect, in a second possible implementation manner of the first aspect, the performing NLP on the word text, to determine a matching field of the word text includes performing word matching for the word text according to field term bases of M fields, to determine the matching field of the word text from the M fields, where M is greater than or equal to 1.

With reference to the first possible implementation manner of the first aspect, in a third possible implementation manner of the first aspect, the performing NLP on the word text, to determine a matching field of the word text includes performing word segmentation on the word text according to field term bases of M fields to obtain a word segmentation result corresponding to at least one field, where M is greater than or equal to 1 and the at least one field belongs to the M fields; and performing, according to a field model of each field of the at least one field, matching for the word segmentation result corresponding to the at least one field, to determine the matching field of the word text from the at least one field.

With reference to the first, second, or third possible implementation manner of the first aspect, in a fourth possible implementation manner of the first aspect, a field corresponding to NLP includes at least one of an important incoming call field, a chat field, a left message field, a reminder setting field, or a query field.

With reference to any one of the first to the fourth possible implementation manners of the first aspect, in a fifth possible implementation manner of the first aspect, the performing, according to the matching field of the word text, the reply operation with respect to the first terminal or the notification operation with respect to the second terminal includes presenting a notification message using the second terminal by means of an in-time notification when the matching field of the word text belongs to the important incoming call field.

With reference to the fifth possible implementation manner of the first aspect, in a sixth possible implementation manner of the first aspect, when the matching field of the word text belongs to the important incoming call field, the performing the reply operation with respect to the first terminal or the notification operation with respect to the second terminal includes while the notification message is presented using the second terminal by means of an in-time notification, instructing, by vibrating or ringing the second terminal, a user to check the notification message.

With reference to any one of the first to the sixth possible implementation manners of the first aspect, in a seventh possible implementation manner of the first aspect, the performing, according to the matching field of the word text, the reply operation with respect to the first terminal or the notification operation with respect to the second terminal includes determining a reply text according to the matching field of the word text; performing speech synthesis on the reply text to obtain a reply speech; and sending the reply speech to the first terminal.

With reference to the first aspect or any one of the foregoing possible implementation manners of the first aspect, in an eighth possible implementation manner of the first aspect, the performing, according to the word text, a reply operation with respect to the first terminal or a notification operation with respect to the second terminal includes sending a mail to a corresponding mailbox of the second terminal according to the word text by sending a mail, or presenting the word text using the second terminal, where the mail carries the word text.

With reference to the first aspect or any one of the foregoing possible implementation manners of the first aspect, in a ninth possible implementation manner of the first aspect, the sending a call response to the first terminal includes sending the call response to the first terminal when it is determined that at least one condition of the following conditions is met; a location of the second terminal belongs to a pre-determined area; a set mode of the second terminal is a silent mode; a set mode of the second terminal is an outdoor mode; a time when the call request is made falls within a pre-determined time; a requester of the call request is in a preset address book; a quantity of times that the requester of the call request makes a call within a pre-determined time range reaches a pre-determined quantity of times; or call duration of the call request meets pre-determined duration.

With reference to the first aspect or any one of the foregoing possible implementation manners of the first aspect, in a tenth possible implementation manner of the first aspect, the method further includes presenting a configuration interface using a display device of the second terminal, where the configuration interface is used by a user to enter configuration information, and the configuration information is configuration information used to implement a voice mailbox function.

With reference to the first aspect or any one of the foregoing possible implementation manners of the first aspect, in an eleventh possible implementation manner of the first aspect, the method further includes recording the voice message to acquire a recorded file; and storing the recorded file to help a user of the second terminal check the recorded file.

According to a second aspect, an apparatus for implementing a voice mailbox is provided, including a receiving module, a sending module, a conversion module, and an execution module, where the receiving module is configured to receive a call request that is from a first terminal and whose destination address is a second terminal; the sending module is configured to send a call response to the first terminal based on the call request received by the receiving module, where the call response is used to instruct a user of the first terminal to leave a voice message; the receiving module is further configured to receive a voice message that is sent by the first terminal after the call response is received; the conversion module is configured to recognize words in the voice message received by the receiving module, to convert the voice message into a word text; and the execution module is configured to perform, according to the word text obtained after conversion performed by the conversion module, a reply operation with respect to the first terminal or a notification operation with respect to the second terminal.

With reference to the second aspect, in a first possible implementation manner of the second aspect, the execution module includes a determining unit and an execution unit, where the determining unit is configured to perform NLP on the word text obtained after conversion performed by the conversion module, to determine a matching field of the word text; and the execution unit is configured to perform, according to the matching field, which is determined by the determining unit, of the word text, the reply operation with respect to the first terminal or the notification operation with respect to the second terminal.

With reference to the first possible implementation manner of the second aspect, in a second possible implementation manner of the second aspect, the determining unit includes a determining subunit, where the determining subunit is configured to perform word matching for the word text according to field term bases of M fields, to determine the matching field of the word text from the M fields, where M is greater than or equal to 1.

With reference to the first possible implementation manner of the second aspect, in a third possible implementation manner of the second aspect, the determining unit includes a word segmentation subunit and a matching subunit, where the word segmentation subunit is configured to perform, according to field term bases of M fields, word segmentation on the word text obtained after conversion performed by the conversion module, to obtain a word segmentation result corresponding to at least one field, where M is greater than or equal to 1 and the at least one field belongs to the M fields; and the matching subunit is configured to perform, according to a field model of each field of the at least one field, matching for the word segmentation result that corresponds to the at least one field and that is obtained by the word segmentation subunit, to determine the matching field of the word text from the at least one field.

With reference to the first, second, or third possible implementation manner of the second aspect, in a fourth possible implementation manner of the second aspect, a field corresponding to NLP includes at least one of an important incoming call field, a chat field, a left message field, a reminder setting field, or a query field.

With reference to any one of the first to the fourth possible implementation manners of the second aspect, in a fifth possible implementation manner of the second aspect, the execution unit includes a presentation subunit, where the presentation subunit is configured to present a notification message using the second terminal by means of an in-time notification when the matching field of the word text belongs to the important incoming call field.

With reference to the fifth possible implementation manner of the second aspect, in a sixth possible implementation manner of the second aspect, the execution unit further includes a notification subunit, where the notification subunit is configured to, while the presentation subunit presents the notification message using the second terminal by means of an in-time notification, instruct, by vibrating or ringing the second terminal, a user to check the notification message.

With reference to any one of the first to the sixth possible implementation manners of the second aspect, in a seventh possible implementation manner of the second aspect, the execution unit includes a reply subunit, where the reply subunit is configured to determine a reply text according to the matching field of the word text; perform speech synthesis on the reply text to obtain a reply speech; and send the reply speech to the first terminal.

With reference to the second aspect or any one of the foregoing possible implementation manners of the second aspect, in an eighth possible implementation manner of the second aspect, the execution module is configured to send a mail to a corresponding mailbox of the second terminal, according to the word text obtained after conversion performed by the conversion module, by sending a mail, or present the word text using the second terminal, where the mail carries the word text.

With reference to the second aspect or any one of the foregoing possible implementation manners of the second aspect, in a ninth possible implementation manner of the second aspect, the apparatus further includes a determining module, where the determining module is configured to determine whether at least one of the following conditions is met: a location of the second terminal belongs to a pre-determined area; a set mode of the second terminal is a silent mode; a set mode of the second terminal is an outdoor mode; a time when the call request is made falls within a pre-determined time; a requester of the call request is in a preset address book; a quantity of times that the requester of the call request makes a call within a pre-determined time range reaches a pre-determined quantity of times; or call duration of the call request meets pre-determined duration; and the sending module is configured to send the call response to the first terminal when the determining module determines that at least one of the foregoing conditions is met.

With reference to the second aspect or any one of the foregoing possible implementation manners of the second aspect, in a tenth possible implementation manner of the second aspect, the apparatus further includes a presentation module, where the presentation module is configured to present a configuration interface using a display device of the second terminal, where the configuration interface is used by a user to enter configuration information, and the configuration information is configuration information used to implement a voice mailbox function.

With reference to the second aspect or any one of the foregoing possible implementation manners of the second aspect, in an eleventh possible implementation manner of the second aspect, the apparatus further includes a recording module and a storage module, where the recording module is configured to record the voice message received by the receiving module to acquire a recorded file; and the storage module is configured to store the recorded file recorded by the recording module, to help a user of the second terminal check the recorded file.

With reference to the second aspect or any one of the foregoing possible implementation manners of the second aspect, in a twelfth possible implementation manner of the second aspect, the apparatus is the second terminal or a server in the Internet.

According to a third aspect, an apparatus for implementing a voice mailbox is provided, including a network interface, a bus, a processor, and a memory, where the network interface is configured to implement a communication connection to at least one other network element, the bus is configured for communication connections between internal parts of the apparatus, the memory is configured to store program code, and the processor is configured to invoke the program code stored in the memory, to perform the following operations: receiving, using the network interface, a call request that is from a first terminal and whose destination address is a second terminal; sending a call response to the first terminal based on the call request using the network interface, where the call response is used to instruct a user of the first terminal to leave a voice message; receiving, using the network interface, a voice message that is sent by the first terminal after the call response is received; recognizing words in the voice message, to convert the voice message into a word text; and performing, according to the word text, a reply operation with respect to the first terminal or a notification operation with respect to the second terminal.

With reference to the third aspect, in a first possible implementation manner of the third aspect, the processor is configured to invoke the program code stored in the memory, to perform the following operations: performing NLP on the word text, to determine a matching field of the word text; and performing, according to the matching field of the word text, the reply operation with respect to the first terminal or the notification operation with respect to the second terminal.

With reference to the first possible implementation manner of the third aspect, in a second possible implementation manner of the third aspect, the processor is configured to invoke the program code stored in the memory, to perform the following operation: performing word matching for the word text according to field term bases of M fields, to determine the matching field of the word text from the M fields, where M is greater than or equal to 1.

With reference to the first possible implementation manner of the third aspect, in a third possible implementation manner of the third aspect, the processor is configured to invoke the program code stored in the memory, to perform the following operations: performing word segmentation on the word text according to field term bases of M fields, to obtain a word segmentation result corresponding to at least one field, where M is greater than or equal to 1 and the at least one field belongs to the M fields; and performing, according to a field model of each field of the at least one field, matching for the word segmentation result corresponding to the at least one field, to determine the matching field of the word text from the at least one field.

With reference to the first, second, or third possible implementation manner of the third aspect, in a fourth possible implementation manner of the third aspect, a field corresponding to NLP includes at least one of an important incoming call field, a chat field, a left message field, a reminder setting field, or a query field.

With reference to any one of the first to the fourth possible implementation manners of the third aspect, in a fifth possible implementation manner of the third aspect, the processor is configured to invoke the program code stored in the memory, to perform the following operation: presenting a notification message using the second terminal by means of an in-time notification when the matching field of the word text belongs to the important incoming call field.

With reference to the fifth possible implementation manner of the third aspect, in a sixth possible implementation manner of the third aspect, the processor is configured to invoke the program code stored in the memory, to perform the following operation: while the notification message is presented using the second terminal by means of an in-time notification, instructing, by vibrating or ringing the second terminal, a user to check the notification message.

With reference to any one of the first to the sixth possible implementation manners of the third aspect, in a seventh possible implementation manner of the third aspect, the processor is configured to invoke the program code stored in the memory, to perform the following operations: determining a reply text according to the matching field of the word text; performing speech synthesis on the reply text to obtain a reply speech; and sending the reply speech to the first terminal using the network interface.

With reference to the third aspect or any one of the foregoing possible implementation manners of the third aspect, in an eighth possible implementation manner of the third aspect, the processor is configured to invoke the program code stored in the memory, to perform the following operation: sending a mail to a corresponding mailbox of the second terminal, according to the word text through the network interface, by sending a mail, or presenting the word text using the second terminal, where the mail carries the word text.

With reference to the third aspect or any one of the foregoing possible implementation manners of the third aspect, in a ninth possible implementation manner of the third aspect, the processor is configured to invoke the program code stored in the memory, to perform the following operation: sending the call response to the first terminal when it is determined that at least one condition of the following conditions is met: a location of the second terminal belongs to a pre-determined area; a set mode of the second terminal is a silent mode; a set mode of the second terminal is an outdoor mode; a time when the call request is made falls within a pre-determined time; a requester of the call request is in a preset address book; a quantity of times that the requester of the call request makes a call within a pre-determined time range reaches a pre-determined quantity of times; or call duration of the call request meets pre-determined duration.

With reference to the third aspect or any one of the foregoing possible implementation manners of the third aspect, in a tenth possible implementation manner of the third aspect, the processor is configured to invoke the program code stored in the memory, to further perform the following operation: presenting a configuration interface using a display device of the second terminal, where the configuration interface is used by a user to enter configuration information, and the configuration information is configuration information used to implement a voice mailbox function.

With reference to the third aspect or any one of the foregoing possible implementation manners of the third aspect, in an eleventh possible implementation manner of the third aspect, the processor is configured to invoke the program code stored in the memory, to further perform the following operations: recording the voice message to acquire a recorded file; and storing the recorded file to help a user of the second terminal check the recorded file.

With reference to the third aspect or any one of the foregoing possible implementation manners of the third aspect, in a twelfth possible implementation manner of the third aspect, the apparatus is the second terminal or a server in the Internet.

Therefore, in the embodiments of the present application, after a voice message sent by a first terminal to a second terminal is received, the voice message is converted into a word text, and a reply operation with respect to the first terminal or a notification operation with respect to the second terminal is performed according the word text. Because the voice message is converted into the word text and the word text is easier to process, more functions can be implemented, or the word text can enable a user to acquire call content by means of viewing. Therefore, the embodiments of the present application make the reply operation with respect to the first terminal or the notification operation with respect to the second terminal more flexible and more intelligent, and therefore make a function of a voice mailbox stronger and more intelligent.

### BRIEF DESCRIPTION OF DRAWINGS

To describe the technical solutions in the embodiments of the present application more clearly, the following briefly describes the accompanying drawings required for describing the embodiments. The accompanying drawings in the following description show merely some embodiments of the present application, and a person of ordinary skill in the art may still derive other drawings from these accompanying drawings without creative efforts.

FIG. 1 is a schematic flowchart of a method for implementing a voice mailbox according to an embodiment of the present application;

FIG. 2 is a schematic flowchart of a method for implementing a voice mailbox according to another embodiment of the present application;

FIG. 3 is a schematic flowchart of a method for implementing a voice mailbox according to another embodiment of the present application;

FIG. 4 is a schematic flowchart of a method for implementing a voice mailbox according to another embodiment of the present application;

FIG. 5 is a schematic flowchart of a method for implementing a voice mailbox according to another embodiment of the present application;

FIG. 6 is a schematic flowchart of a method for implementing a voice mailbox according to another embodiment of the present application;

FIG. 7 is a schematic flowchart of a method for implementing a voice mailbox according to another embodiment of the present application;

FIG. 8 is a schematic block diagram of an apparatus for implementing a voice mailbox according to an embodiment of the present application;

FIG. 9 is a schematic block diagram of an apparatus for implementing a voice mailbox according to another embodiment of the present application; and

FIG. 10 is a schematic block diagram of an apparatus for implementing a voice mailbox according to another embodiment of the present application.

### DESCRIPTION OF EMBODIMENTS

The following clearly describes the technical solutions in the embodiments of the present application with reference to the accompanying drawings in the embodiments of the present application. The described embodiments are some but not all of the embodiments of the present application. All other embodiments obtained by a person of ordinary skill in the art based on the embodiments of the present application without creative efforts shall fall within the protection scope of the present application.

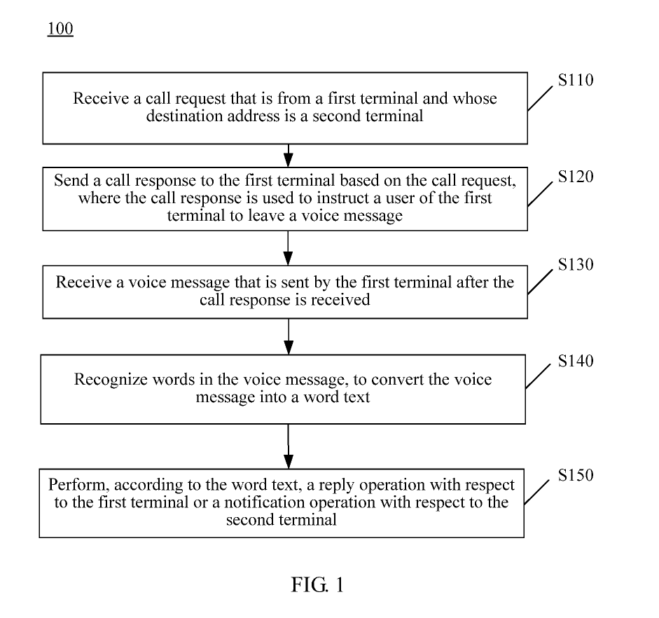

FIG. 1 is a schematic flowchart of a method for implementing a voice mailbox according to an embodiment of the present application. The method 100 may be implemented by a second terminal, or may be implemented by a server in the Internet.

As shown in FIG. 1, the method 100 includes the following steps.

S110. Receive a call request that is from a first terminal and whose destination address is a second terminal.

S120. Send a call response to the first terminal based on the call request, where the call response is used to instruct a user of the first terminal to leave a voice message.

S130. Receive a voice message that is sent by the first terminal after the call response is received.

S140. Recognize words in the voice message, to convert the voice message into a word text.

S150. Perform, according to the word text, a reply operation with respect to the first terminal or a notification operation with respect to the second terminal.

In this embodiment of the present application, after receiving the call request that is from the first terminal and whose destination address is the second terminal, the second terminal or a server determines that a voice mailbox needs to be enabled; after determining that the voice mailbox needs to be enabled, the second terminal or the server sends the call response to the first terminal, where the call response is used to instruct the user of the first terminal to leave a message; after receiving the call response from the second terminal, the first terminal collects the voice message of the user, and sends the voice message to the second terminal or the server; after receiving the voice message sent by the first terminal, the second terminal or the server may recognize words in the voice message, to convert the voice message into the word text; then the second terminal or the server performs, according to the word text, the reply operation with respect to the first terminal and/or the notification operation with respect to the second terminal.

Therefore, in this embodiment of the present application, after a voice message that is sent by a first terminal to a second terminal is received, the voice message is converted into a word text, and a reply operation with respect to the first terminal or a notification operation with respect to the second terminal is performed according the word text. Because the voice message is converted into the word text and the word text is easier to process, more functions can be implemented, or the word text can enable a user to acquire call content by means of viewing. Therefore, this embodiment of the present application makes the reply operation with respect to the first terminal or the notification operation with respect to the second terminal more flexible and more intelligent, and therefore makes a function of a voice mailbox stronger and more intelligent.

Optionally, in this embodiment of the present application, the method 100 may be implemented by the second terminal. That is, after receiving the call request sent from the first terminal to the second terminal, the second terminal may directly enable a voice mailbox to perform subsequent operations.

Alternatively, in this embodiment of the present application, the method 100 may be implemented by a server node in the Internet. After receiving the call request sent from the first terminal to the second terminal, the second terminal may forward the call request to the server node, and the server node executes a voice mailbox function; or after determining that a voice mailbox function with respect to the second terminal needs to be executed, the server node acquires the call request before the call request reaches the second terminal, and then executes the voice mailbox function.

Using a terminal or a server node in the Internet to implement the voice mailbox in this embodiment of the present application may resolve a problem of expenses incurred for a conventional voice mailbox relying on an operator.

In this embodiment of the present application, the call response is used to instruct the user of the first terminal to leave a voice message, where the call response may carry a greeting recorded by a user of the second terminal, or carry a voice converted from words configured by a user, or carry a system default self introduction of the voice mailbox, or the like.

Optionally, in this embodiment of the present application, the performing, according to the word text, a reply operation with respect to the first terminal or a notification operation with respect to the second terminal in S150 may include performing (NLP) on the word text, to acquire a matching field of the word text; and performing, according to the matching field of the word text, the reply operation with respect to the first terminal or the notification operation with respect to the second terminal.

In other words, after converting the voice message from the first terminal into the word text, the second terminal or the server may perform NLP on the word text, to obtain the matching field of the word text, and then the second terminal or the server may perform, according to the matching field of the word text, the reply operation with respect to the first terminal and/or the notification operation with respect to the second terminal.

In this embodiment of the present application, the following manner may be used to implement NLP on the word text, to determine the matching field of the word text: performing word segmentation on the word text according to field term bases of M fields, to obtain a word segmentation result corresponding to at least one field, where M is greater than or equal to 1 and the at least one field belongs to the M fields; and performing, according to a field model of each field of the at least one field, matching for the word segmentation result corresponding to the at least one field, to determine the matching field of the word text from the at least one field.

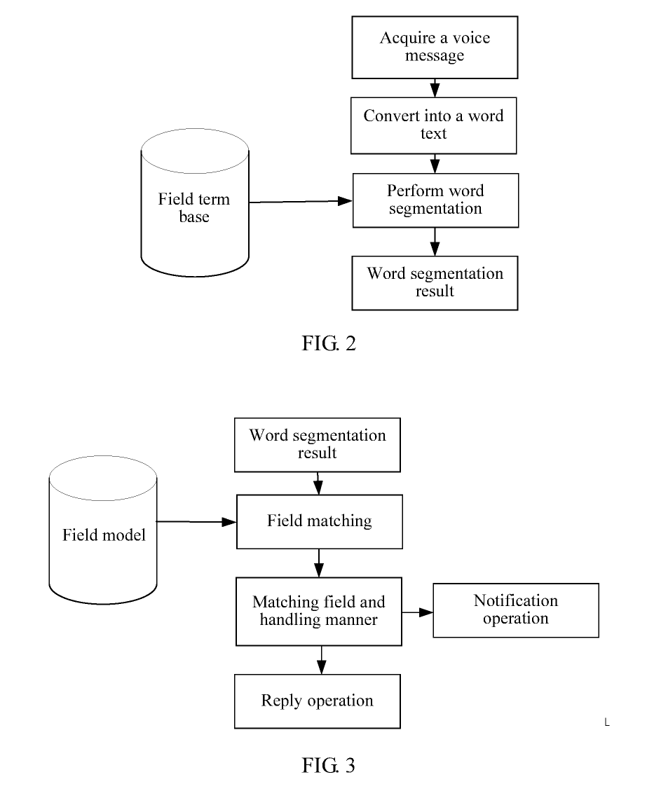

As shown in FIG. 2, after converting the voice message into the word text, the second terminal or the server may acquire a field term base of each field stored in a memory, and perform, by field, word segmentation on the word text using a word segmentation algorithm according to the field term base of each field, to obtain a word segmentation result of the at least one field, where the word segmentation algorithm may be a maximum matching method or a statistics method, and certainly may be another word segmentation algorithm. Then, for example, as shown in FIG. 3, according to the field model of each field of the foregoing at least one field, matching is performed for a word segmentation result of each field, and a field with a high matching degree is determined as the matching field of the word text. Then, the second terminal or the server may perform, according to the matching field of the word text and a corresponding handling manner, the reply operation with respect to the first terminal and/or the notification operation with respect to the second terminal.

In this embodiment of the present application, the following manner may also be used to implement NLP on the word text, to acquire the matching field of the word text: performing word matching for the word text according to field term bases of M fields, to determine the matching field of the word text from the M fields, where M is greater than or equal to 1.

After converting the voice message into the word text, the second terminal or the server may acquire a field term base of each field stored in a memory; performs, by field, word matching on the word text using a word segmentation algorithm according to the field term base of each field; and then may determine the matching field of the word text, and may determine a field with a maximum quantity of segmented words as the matching field of the word text. Then, the second terminal or the server may perform, according to the matching field of the word text and a corresponding handling manner, the reply operation with respect to the first terminal and/or the notification operation with respect to the second terminal.

In this embodiment of the present application, a field corresponding to NLP may include at least one of an important incoming call field, a chat field, a left message field, or a reminder setting field. Field term bases of these fields may include some words that obviously present a field characteristic.

The important incoming call field indicates that an incoming call from a caller is an important incoming call and needs to be handled in time by the user. A field term base of the field may include, for example, “fire”, “urgency”, and “accident”.

The reminder setting field indicates that a reminder needs to be set on the terminal for an incoming call from a caller. The user may be reminded at a time A to do, at the time A, what is required by the caller, where the time A is also a time required by the caller; or the user may be reminded at a time B to do, at a time A, what is required by the caller, where the time A is a time required by the caller, and a time difference between the time B and the time A is C, where C may be default on the terminal or may be set by the user of the terminal. For example, a field term base of the field may include “reminder”, “11:00”, “10:00”, and the like.

The left message field indicates that an incoming call from a caller is only to leave a message and does not need urgent handling, and that the user may check the message at a convenient time. The user may also be reminded by means of reminder setting, only that a specific notification time set for a reminder may be default on the terminal or may be set by the user of the terminal. For example, the terminal may notify the user of a left message one hour after receiving a call request. Certainly, only a recorded speech may also be stored without any reminder, for the user to check voluntarily. For example, a field term base of this field may include “message”, “tell”, and the like.

The chat field is a field other than the important incoming call field, the left message field, and the reminder setting field. An implementation manner of a field model of the chat field may be collecting a large quantity of dialog texts (from web pages, microblogs, forums, and the like) for study. After the study, an interrogative sentence (in a dialog text corpus) that has a closest similarity with a text of a voice input is computed, and an answer to the interrogative sentence is used as a reply.

In this embodiment of the present application, a field model includes, but is not limited to, a sentence pattern base, a rule base, and a corpus of a corresponding field.

In this embodiment of the present application, the rule-based approach (RBA) or the statistic-based approach (SBA) may be used to perform matching for the word segmentation result of each field according to a field model. Certainly, another algorithm may also be used to perform field matching, which is not limited in this embodiment of the present application. For better understanding of the present application, the following describes RBA-based and SBA-based matching algorithms in details.

In the RBA, commonly used sentence patterns and terms in a corresponding field are abstracted and converted into some specific symbols, and these symbols are permutated and combined to form some rules. Generally, one rule corresponds to one type of semantics and one corresponding handling method. In specific implementation, one rule may correspond to one regular expression. The regular expression may be compared with a word segmentation result of the field to learn whether they match. For example, in the important incoming call field, a word segmentation result “urgency” may correspond to a rule A (certainly, the rule may also correspond to another word segmentation result, such as “important matter”). When including “urgency”, a word segmentation result corresponding to the word text matches the rule A. After matching, a handling method corresponding to the rule A is invoked. In this way, a voice message of a user is mapped to a handling method, and different voice messages are handled differently.

In the SBA, a large quantity of actual instances (a corpus) of a corresponding field are collected, for example, from web pages, microblogs, or forums, to abstract a feature (a particular word, a part of speech, a frequency of use, a combination manner, a position in a sentence, and the like) and study based on a probability. After the study, a matching degree may be computed for any input word. For example, in the important incoming call field, if the word segmentation result corresponding to the word text of the caller has a high matching degree with the important incoming call field, it can be known that an importance degree of the call of the caller is high, so that corresponding handling is performed.

It should be understood that, in this embodiment of the present application, word segmentation may also be not performed for the word text, matching is directly performed between the word text and each field model, a field that has a high matching degree is determined as the matching field of the word text, and a corresponding handling manner is determined. If there is only one field model, the field model may be directly determined as the matching field, and a corresponding handling manner is determined based on the field model of the matching field.

For example, a large quantity of dialog texts may be collected (from web pages, microblogs, forums, and the like) for study to establish a field model. Then, in the field model, an interrogative sentence (in a dialog text corpus) that has a closest similarity with the word text is acquired, and an answer to the interrogative sentence is used as a reply. In this case, word segmentation may be skipped for the word text.

It should also be understood that, in this embodiment of the present application, matching may be performed for the field models of the fields in turn. When a matching degree of a field cannot reach a pre-determined degree, matching is performed for a next field. If a pre-determined degree is reached, the field may be determined as the matching field. For example, when the word text does not match any of the important incoming call field, the left message field, and the reminder setting field, matching may be further performed between the word text and the chat field. In this embodiment of the present application, matching may also be performed according to the field models of all fields, and a field that has a highest matching degree is selected as the matching field.

It should also be understood that, in this embodiment of the present application, only the matching field of the word text is obtained at NLP, and then a corresponding handling manner is determined according to the matching field. That is, determining a handling manner is not an action belonging to NLP. Alternatively, when NLP is performed on the word text, not only the matching field of the word text may be obtained, but also a handling manner corresponding to the matching field may be determined. That is, determining a handling manner is an action belonging to NLP, for example, the foregoing RBA algorithm. However, even so, the handling manner corresponding to the matching field may still be determined only after the matching field is determined. This may also be referred to as determining the corresponding handling manner based on the matching field of the word text, or performing, according to the matching field of the word text, the reply operation with respect to the first terminal or the notification operation with respect to the second terminal.

In this embodiment of the present application, when the matching field of the word text belongs to the important incoming call field, a notification message may be presented using the second terminal by means of an in-time notification. If an execution entity is the server, a short message service message notification may be immediately sent to the second terminal, where content of the short message service message notification may include a telephone number of the caller, a name of a contact, notification content, and the like, and the notification content includes, but is not limited to, the word text corresponding to the voice message, and further, a recorded voice message may be sent. If the execution entity is the second terminal, the notification message may be presented using a display device of the second terminal, where the notification message may include a telephone number of the caller, a name of a contact, notification content, and the like, and the notification content includes, but is not limited to, the word text corresponding to the voice message, and the user may be notified, by vibrating or ringing the second terminal, that the notification message has been presented using the second terminal.

In this embodiment of the present application, when the matching field of the word text does not belong to the important incoming call field, the notification operation with respect to the second terminal is performed based on a non-user-disturbing principle. For example, the notification message may be presented using the second terminal by means of a subsequent notification. For example, the second terminal may notify the user by means of reminder setting or the like, or the server sends a short message service message notification to the second terminal one hour later; or the notification message may be presented in time, only that the notification message is presented in silence.

Optionally, in this embodiment of the present application, after field matching is performed, a mail may be further sent to a mailbox corresponding to the second terminal, where the mail may carry a telephone number of a caller, a name of a contact, notification content, and the like, and the notification content includes, but is not limited to, the word text corresponding to the voice message or a recorded voice message.

Optionally, in this embodiment of the present application, the word text obtained after conversion may also be directly sent to the mailbox corresponding to the second terminal, or the word text is directly presented using the second terminal, so that the user may acquire the call content by means of viewing when it is not convenient for the user to answer the call.

In this embodiment of the present application, a mail is sent to the mailbox corresponding to the second terminal, so that, if the user does not take the terminal, an incoming call notification and corresponding incoming call content can be sent to the user in time, or if it is not convenient for the user to answer the call, a notification message can be sent to the user based on a non-user-disturbing principle (for example, word text may be sent so that the user can acquire the call content by means of viewing), or when the second terminal is a conventional fixed-line phone, an incoming call notification may be sent to the user of the second terminal.

It should be understood that the notification manner in the foregoing example is merely a specific implementation manner of this embodiment of the present application. This embodiment of the present application may have another notification manner. For example, a notification message may be not sent to the user terminal until a query request of the user is received, where the notification message may also include the telephone number of the caller, the name of the contact, the notification content, and the like. So long as the user is made to learn about the incoming call based on the word text, it may be considered that the notification is performing, based on the word text, the notification operation with respect to the second terminal.

In this embodiment of the present application, after the matching field of the word text is determined, a reply text may be determined, then speech synthesis is performed on the reply text to obtain a reply speech, and the reply speech is sent to the first terminal.

After the matching field corresponding to the word text is determined, the reply text with respect to the first terminal may be determined. For example, if the matching field is the reminder setting field and a message is created with respect to the second terminal, a reply text such as “A reminder has been created” may be generated, a reply speech is generated by means of automatic speech synthesis (ASS), and the reply speech is sent to the first terminal.

Optionally, this embodiment of the present application may include not only the important incoming call field, the chat field, the left message field, and the reminder setting field, but also an extended field. For example, a query field may be included, and the query field may further include a weather query field, a location query field, and the like.

In this embodiment of the present application, the server or the second terminal may execute work related to invoking a third party. For example, when the matching field is the weather query field, weather at a location of the second terminal may be acquired from a third party, and a reply speech is generated based on the weather information at the location of the second terminal and sent to the first terminal. Further, a notification message may be further sent to the second terminal to notify the user of the second terminal that the first terminal has queried the weather at the location of the second terminal. When the NLP field includes the weather query field, a field term base of the field may include “weather”, “rain”, city whose weather is to be queried for, and the like.

Therefore, in this embodiment of the present application, the matching field of the word text is determined by means of NLP, and the reply operation with respect to the first terminal or the notification operation with respect to the second terminal is performed based on the matching field of the word text, so that the reply operation or the notification operation is more target-oriented. For example, when the matching field of the word text is the important incoming call field, the user may be notified in time, and when the matching field of the word text does not belong to the important incoming call field, the user may be notified based on a non-user-disturbing principle, thereby making a function of the voice mailbox stronger and more intelligent.

In this embodiment of the present application, the voice mailbox may be enabled in a specific scenario, for example, when a current location of the second terminal meets a first pre-determined condition, or when settings of the second terminal meet a second pre-determined condition, or when the call request meets a third pre-determined condition.

Optionally, the foregoing first pre-determined condition is that the location of the second terminal belongs to a pre-determined area. The user may set an area range, and the voice mailbox is enabled within the area range. In this case, the second terminal may be at least a 3G mobile phone provided with a positioning service.

Optionally, the foregoing second pre-determined condition is that a set mode of the second terminal is a silent mode or an outdoor mode.

Optionally, the foregoing third pre-determined condition includes that a time at which the call request is made falls within a pre-determined time, or that a requester of the call request is in a preset address book, where the preset address book may be a subset of an address book of a user, and the user may add the subset to the foregoing preset address book; and/or the pre-determined condition includes that a quantity of times that the requester of the call request makes a call within a pre-determined time range reaches a pre-determined quantity of times, for example, the requester has made three calls within one hour; and/or the third pre-determined condition includes that call duration of the call request meets pre-determined duration, commonly known as ringing duration, for example, 10 seconds.

It should be understood that the voice mailbox may be enabled when one of the ^{L} foregoing conditions is met, or the voice mailbox may be enabled when more than one of the foregoing conditions is met at the same time. For example, it may be set that the voice mailbox is enabled when the set mode of the terminal is the silent mode and the call duration of the call request is greater than 10 seconds.

Therefore, in this embodiment of the present application, the voice mailbox may be enabled when a scenario that the terminal is in meets a pre-determined scenario (the pre-determined scenario may be configured by the user). For example, the voice mailbox is enabled when the location of the terminal belongs to a pre-determined area or the call request meets a pre-determined condition, so that the voice mailbox may be enabled when it is not convenient for the user to answer the call or when the user cannot answer the call, thereby making a function of the voice mailbox stronger and more intelligent.

In this embodiment of the present application, the voice mailbox may use a default configuration or may be configured by the user. A configuration interface may be presented using the display device of the second terminal, where the configuration interface is an ingress for a user operation. The user may configure the voice mailbox using the interface, so as to implement a function of the voice mailbox. In addition, the configuration interface may further display a current configuration situation. The user may configure a greeting carried in the call response, may configure the foregoing first pre-determined condition, second pre-determined condition, third pre-determined condition, or the like, and may further configure a mail address corresponding to the notification message, and the like. It should be understood that, in this embodiment of the present application, when the execution entity is the server in the Internet, a presentation notification for the configuration interface may be sent to the second terminal, so that the configuration interface is presented using the second terminal, that is, the configuration interface is presented using the display device of the second terminal; or when the execution entity is the second terminal, the configuration interface may be directly presented using the display device of the second terminal.

In this embodiment of the present application, the second terminal or the server may record the voice message to acquire a recorded file and store the recorded file, so that the user of the second terminal may check the recorded file.

Therefore, in this embodiment of the present application, after a voice message that is sent by a first terminal to a second terminal is received, the voice message is converted into a word text, and a reply operation with respect to the first terminal or a notification operation with respect to the second terminal is performed according the word text. Because the voice message is converted into the word text and the word text is easier to process, more functions can be implemented, or the word text can enable a user to acquire call content by means of viewing. Therefore, this embodiment of the present application makes the reply operation with respect to the first terminal or the notification operation with respect to the second terminal more flexible and more intelligent, and therefore makes a function of a voice mailbox stronger and more intelligent. A matching field of the word text is determined by means of NLP, the reply operation with respect to the first terminal or the notification operation with respect to the second terminal is performed based on the matching field of the word text, so that the reply operation or the notification operation is more target-oriented. For example, when the matching field of the word text is an important incoming call field, the user may be notified in time, and when the matching field of the word text does not belong to the important incoming call field, the user may be notified based on a non-user-disturbing principle, thereby making a function of the voice mailbox stronger and more intelligent. In addition, the voice mailbox may be enabled when a scenario that the terminal is in meets a pre-determined scenario, where the pre-determined scenario may be configured by the user. For example, the voice mailbox is enabled when a location of the terminal belongs to a pre-determined area or a call request meets a pre-determined condition, so that the voice mailbox may be enabled when it is not convenient for the user to answer the call or when the user cannot answer the call, thereby making a function of the voice mailbox stronger and more intelligent.

For clearer understanding of the present application, the following describes several scenarios that this embodiment of the present application may be applied to.

Scenario A: A user A enters a conference room to attend a conference and clicks a voice mailbox application on a terminal. The terminal presents a configuration interface, and the user may set a voice mailbox enablement area using the configuration interface. The terminal may acquire current global positioning system (GPS) coordinates using a positioning service or from a third party, the user may set the voice mailbox enablement area based on the current GPS coordinates, for example, an area with a center being the current GPS coordinates and a radius of ten meters, and certainly, the area may also be rectangular or in another shape. After detecting a call request from another terminal, the terminal may directly enable a voice mailbox. When the user leaves the set area, a voice mailbox function is disabled. If entering the pre-determined area again, the terminal detects that its location belongs to the pre-determined area, and then the terminal may directly enable the voice mailbox after receiving a call request from another terminal.

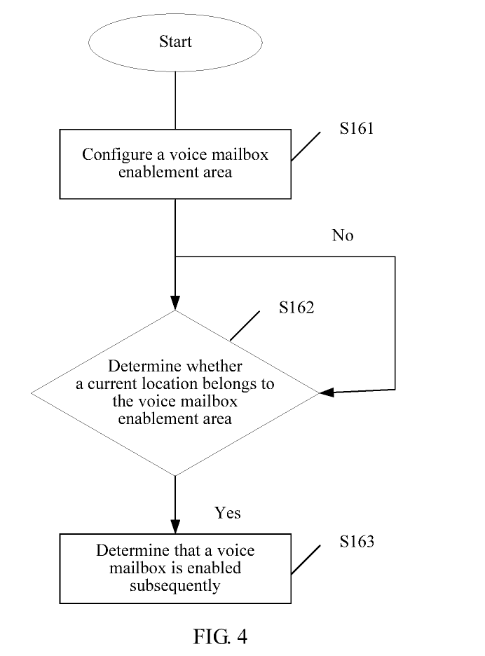

For example, as shown in FIG. 4, in S161, a user may configure a voice mailbox enablement area. In S162, a terminal detects, based on a specific cycle, whether a current location belongs to the voice mailbox enablement area. If the current location belongs to the voice mailbox enablement area, a working mode of the terminal may be changed in S163 to ensure that the voice mailbox is enabled when a subsequent call request is received. If the current location does not belong to the voice mailbox enablement area, the detection continues.

Scenario B: A user A is used to going to bed at 12:00 midnight, and a voice mailbox enablement time period may be set to, for example, 12:00 midnight to 7:00 a.m. In this way, if there is an unimportant incoming call at night, a voice mailbox may be enabled and a notification operation is performed based on a non-user-disturbing principle. After getting up, A may check a related voice message or reminder, if any, and rest of the user is not disturbed.

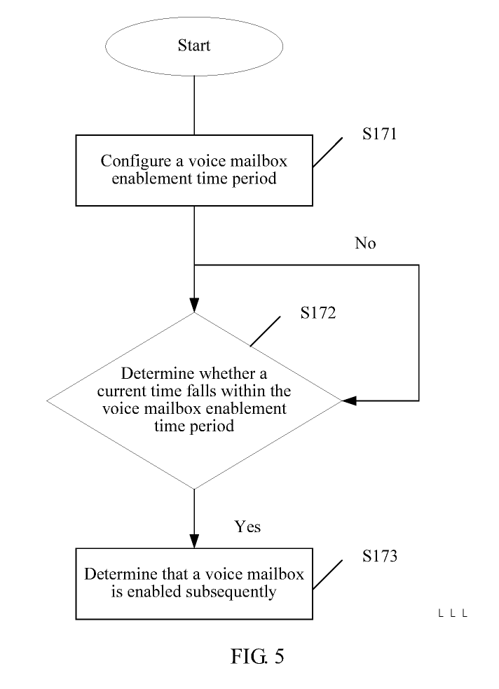

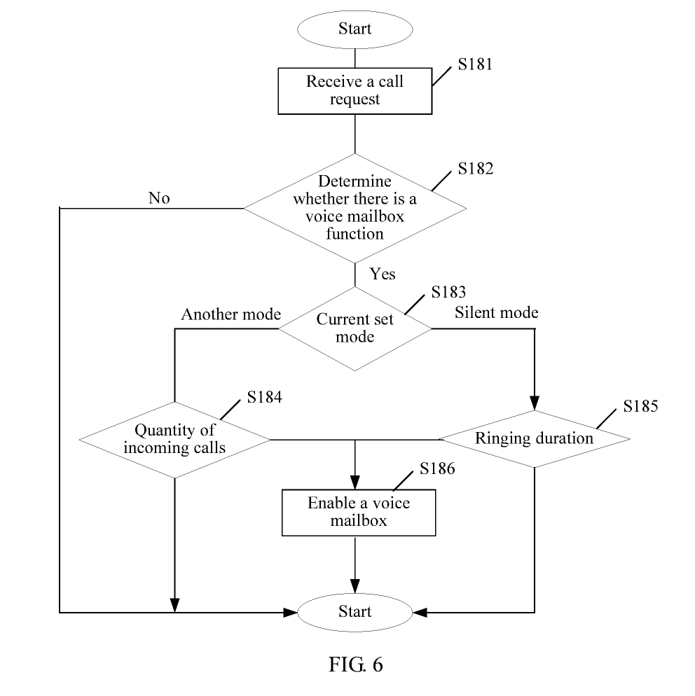

For example, as shown in FIG. 5, in S171, a user may configure a voice mailbox enablement time period. In S172, a terminal detects, based on a specific cycle, whether a current time falls within the voice mailbox enablement time period. If the current time falls within the voice mailbox enablement time period, a working mode of the terminal may be changed in S173 to ensure that the voice mailbox is enabled when a subsequent call request is received; if the current time does not fall within the voice mailbox enablement time period, the detection continues.

Scenario C: A terminal is currently in a silent mode when a call is coming. The terminal detects that a current mode is the silent mode and starts timing. When the timing lasts for 10 seconds, a working mode may be changed to determine that a voice mailbox needs to be enabled, and then the voice mailbox is immediately enabled.

For example, as shown in FIG. 6, after a terminal receives a call request in S181 and it is determined, in S182, that the terminal has a voice mailbox function, a current set mode may be determined in S183. If the current set mode is a silent mode, S185 is performed to determine ringing duration, and after the ringing duration exceeds pre-determined ringing duration, S186 is performed, that is, a voice mailbox is enabled. It should be understood that the ringing duration is merely a common expression of a call waiting time of a caller, and ringing may not necessarily happen. For example, if a user enables vibration only, the duration is vibration duration.

Scenario D: A terminal is in an outdoor mode and there is a call coming from a contact B. The terminal detects a set mode and one is recorded in a counter of incoming calls from B. The call coming this time is not handled. Soon after, B makes a call again, and one is added to the counter of incoming calls from B. When a quantity of incoming calls reaches a pre-determined quantity, a voice mailbox is enabled.

For example, as shown in FIG. 6, when a current set mode is a non-silent mode, S184 may be performed to determine a quantity of incoming calls. If the quantity of incoming calls exceeds a pre-determined quantity, S186 is performed to enable a voice mailbox.

Scenario E: A user A is attending a conference at a conference room, and has set an enablement area for a voice mailbox of a terminal. When a contact L makes a call, the voice mailbox is enabled and a greeting (which may be a recorded speech of A) is played. The contact L knows the situation, and leaves a voice message “Please tell A that we will catch up another day.” The terminal converts the voice message into a word text by means of speech recognition, performs word segmentation according to a field term base of a left message field to obtain a word segmentation result (Please/tell/A/we will/catch up/another day), and performs matching according to the word segmentation result to obtain that the matching field is indeed the left message field. A terminal A stores the voice message “Please tell A we will catch up another day” of the contact L, generates a reply “A message has been created. Anything else?”, performs speech synthesis, returns the reply to the contact L, and prepares to receive another possible request subsequently from the contact L. The user A is not aware of the incoming call during the total conference and therefore is not disturbed.

Scenario F: A user A forgets to carry a mobile phone one day, and a contract S makes a call. S is in a preset list for enabling a voice mailbox, and therefore the voice mailbox is enabled. A terminal plays a self introduction greeting prompting the contact S to leave a message, and sets a reminder for S, and so on. The contact S leaves a voice message “Please remind A at 11:00 tonight that overtime work is required tomorrow.” The terminal converts the voice message into a word text, performs word segmentation and field matching, and determines that a matching field is a “reminder setting” field. A reminder item that will be activated at 11:00 p.m. is set with the content “S called you today to tell that you were required to work overtime tomorrow.”

Scenario G: A user A is at a conference, and has set an enablement area for a voice mailbox of a terminal. When a contact R makes a call, the voice mailbox is enabled and a greeting is played. R leaves a voice message “There is a fire home.” The terminal converts the voice message into a word text, performs word segmentation and field matching, determines that a matching field is the “important incoming call” field, and immediately invokes a vibrating or ringing function of a mobile phone to remind A that there is an important incoming call.

It should be understood that the terminal in the foregoing scenarios A to G may correspond to the second terminal in the method 100, and is capable of implementing a corresponding function of the second terminal.

It should also be understood that the foregoing scenarios are merely exemplary description to facilitate reader understanding, and should not constitute any limitation to an application scenario of this embodiment of the present application.

It should also be understood that, in this embodiment of the present application, if a voice mailbox is not enabled, it indicates that a call request of a caller is not processed at all but waits for a user to answer.

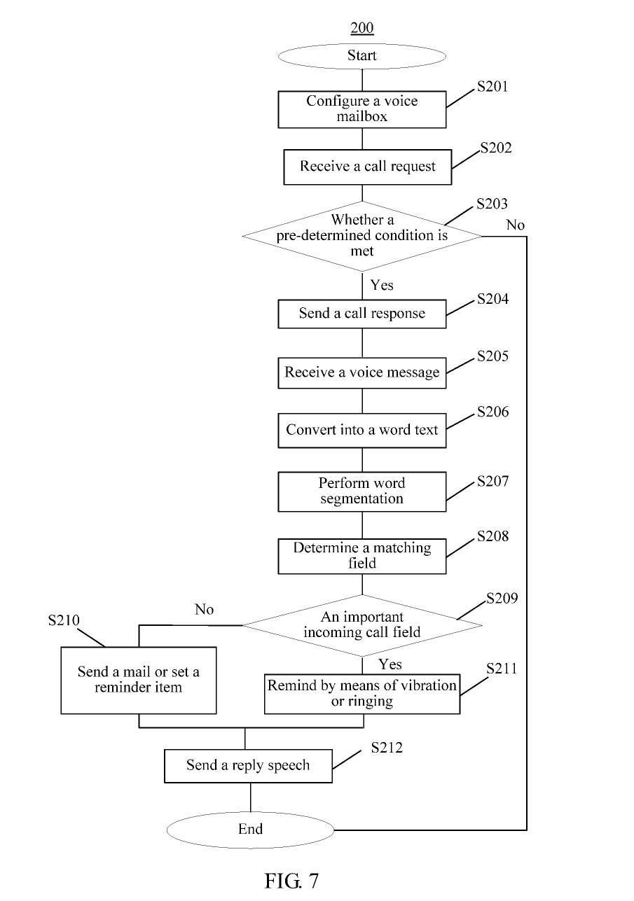

FIG. 7 is a schematic flowchart of a method 200 for implementing a voice mailbox according to an embodiment of the present application. The method 200 may be implemented by a terminal or may be implemented by a server. For ease of description, the following uses implementation by a terminal as an example for description.

As shown in FIG. 7, the method 200 includes the following steps.

S201. A terminal A presents a configuration interface on a display device, so as to instruct a user to configure a voice mailbox. The user may configure a pre-determined condition for enabling the voice mailbox. For example, the voice mailbox is enabled when a call request from a terminal or some terminals is received, or a mode (a silent mode or an outdoor mode) for enabling the voice mailbox is set, an area range for enabling the voice mailbox is set, or the like. The user may further configure a manner for reminding the terminal A when a matching field of word text corresponding to a received voice message is an important incoming call field, configure a mailbox corresponding to the voice mailbox, and the like.

S202. The terminal A receives a call request of a terminal B.

S203. The terminal A determines whether a current scenario meets the pre-determined condition, for example, whether a call requester is a set terminal, or whether a current mode is the silent mode, the outdoor mode, or the like. It should be understood that, S203 may be performed before S202, that is, before the call request of the terminal B is received, to determine whether the current scenario meets the pre-determined condition, for example, whether the current mode is the silent mode, the outdoor mode, or the like; and then S204 is directly performed after the call request of the terminal B is received.

S204. The terminal A sends a call response to the terminal B, where the call response is used to instruct a user of the terminal B to leave a voice message, and the call response may carry a greeting recorded by the terminal A, or carry a speech converted from words configured by the user, or carry system default self introduction of the voice mailbox, or the like.

S205. The terminal A receives a voice message sent by the terminal B.

S206. The terminal A converts the voice message of the terminal B into a word text by means of speech recognition.

S207. The terminal A performs word segmentation for the word text according to a field term base, to obtain a word segmentation result of at least one field.

S208. The terminal A performs matching for the word segmentation result according to a field model of the foregoing at least one field, to determine a matching field of the word text.

S209. The terminal A determines whether the matching field of the word text is an important incoming call field, and if the matching field of the word text is the important incoming call field, perform S211; if the matching field of the word text is not the important incoming call field, performs S210, performs S211; if no, performs S210.

S210. The terminal A sends a mail to a mailbox corresponding to the terminal A and sets a reminder or the like.

S211. The terminal A sends a notification message by means of vibration or ringing to remind the user that a current incoming call is an important incoming call.

S212. The terminal A determines a reply text, performs speech synthesis on the reply text to obtain a reply speech, and sends the reply speech to the terminal B.

It should be understood that, in the foregoing method 200, when the terminal A determines, in S203, that the current scenario does not meet the pre-determined condition, it indicates that the voice mailbox is not to be enabled, the call from the terminal B is not processed, but waits for the user to answer.

It should be understood that, the terminal A in the method 200 may correspond to the second terminal in the method 100, and is capable of implementing a corresponding function of the second terminal; the terminal B in the method 200 may correspond to the first terminal in the method 100, and is capable of implementing a corresponding function of the first terminal.

It should also be understood that, in the embodiments of the present application, sequence numbers of the foregoing processes do not indicate order of execution and do not constitute any limitation to the implementation processes of the embodiments of the present application, where the order of execution of the processes is determined by functions and internal logic of the processes.

Therefore, in this embodiment of the present application, after a voice message sent by a terminal B to a terminal A is received, the voice message is converted into a word text, and a reply operation with respect to the terminal B or a notification operation with respect to the terminal A is performed according the word text. Because the voice message is converted into the word text and the word text is easier to process, more functions can be implemented, or the word text can enable a user to acquire call content by means of viewing. Therefore, this embodiment of the present application makes the reply operation with respect to the terminal B or the notification operation with respect to the terminal A more flexible and more intelligent, and therefore makes a function of a voice mailbox stronger and more intelligent. A matching field of the word text is determined by means of NLP, and the reply operation with respect to the terminal B or the notification operation with respect to the terminal A is performed based on the matching field of the word text, so that the reply operation or the notification operation is more target-oriented. For example, when the matching field of the word text is an important incoming call field, the user may be notified in time, and when the matching field of the word text does not belong to the important incoming call field, the user may be notified based on a non-user-disturbing principle, thereby making a function of the voice mailbox stronger and more intelligent. In addition, the voice mailbox may be enabled when a scenario that the terminal is in meets a pre-determined scenario, where the pre-determined scenario may be configured by the user. For example, the voice mailbox is enabled when a location of the terminal belongs to a pre-determined area or a call request meets a pre-determined condition, thereby also making a function of the voice mailbox stronger and more intelligent.

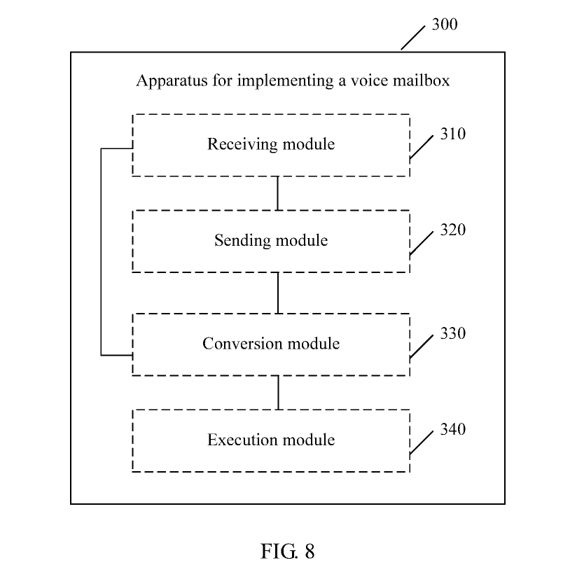

The foregoing describes the method for implementing a voice mailbox according to the embodiments of the present application with reference to FIG. 1 to FIG. 7. The following describes an apparatus for implementing a voice mailbox according to the embodiments of the present application with reference to FIG. 8 to FIG. 10.

FIG. 8 is a schematic block diagram of an apparatus 300 for implementing a voice mailbox according to an embodiment of the present application. As shown in FIG. 8, the apparatus 300 includes a receiving module 310, a sending module 320, a conversion module 330, and an execution module 340, where the receiving module 310 is configured to receive a call request that is from a first terminal and whose destination address is a second terminal; the sending module 320 is configured to send a call response to the first terminal based on the call request received by the receiving module 310, where the call response is used to instruct a user of the first terminal to leave a voice message; the receiving module 310 is further configured to receive a voice message that is sent by the first terminal after the call response is received; the conversion module 330 is configured to recognize words in the voice message received by the receiving module 310, to convert the voice message into a word text; and the execution module 340 is configured to perform, according to the word text obtained after conversion performed by the conversion module 330, a reply operation with respect to the first terminal or a notification operation with respect to the second terminal.

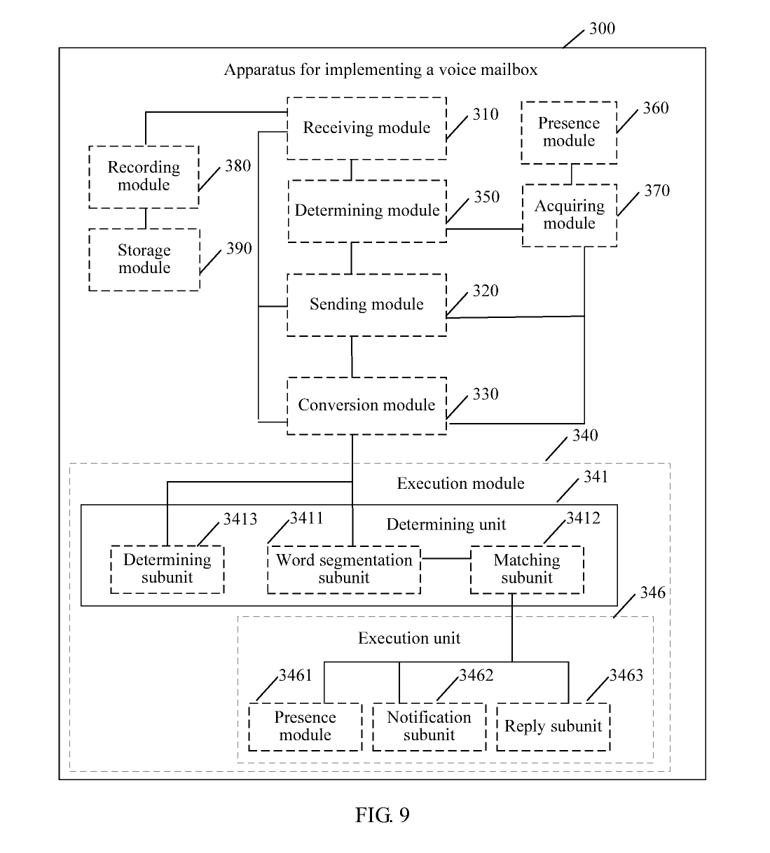

Optionally, in this embodiment of the present application, as shown in FIG. 9, the execution module 340 includes a determining unit 341 and an execution unit 346, where the determining unit 341 is configured to perform NLP on the word text obtained after conversion performed by the conversion module 330, to determine a matching field of the word text; and the execution unit 346 is configured to perform, according to the matching field, which is determined by the determining unit 341, of the word text, the reply operation with respect to the first terminal or the notification operation with respect to the second terminal.

Optionally, in this embodiment of the present application, as shown in FIG. 9, the determining unit 341 includes a determining subunit 3413, where the determining subunit 3413 is configured to perform word matching for the word text according to field term bases of M fields, to determine the matching field of the word text from the M fields, where M is greater than or equal to 1.

Optionally, in this embodiment of the present application, as shown in FIG. 9, the determining unit 341 includes a word segmentation subunit 3411 and a matching subunit 3412, where the word segmentation subunit 3411 is configured to perform, according to field term bases of M fields, word segmentation on the word text obtained after conversion performed by the conversion module, to obtain a word segmentation result corresponding to at least one field, where M is greater than or equal to 1 and the at least one field belongs to the M fields; and the matching subunit 3412 is configured to perform, according to a field model of each field of the at least one field, matching for the word segmentation result that corresponds to the at least one field and that is obtained by the word segmentation subunit 3411, to determine the matching field of the word text from the at least one field.

Optionally, the foregoing determining unit 341 may include a determining subunit 3413 and does not include a word segmentation subunit 3411 or a matching subunit 3412, or the foregoing determining unit 341 may include a word segmentation subunit 3411 and a matching subunit 3412 and does not include a determining subunit 3413, or the foregoing determining unit 341 may include a word segmentation subunit 3411 and a matching subunit 3412, and also include a determining subunit 3413.

Optionally, in this embodiment of the present application, a field corresponding to NLP includes at least one of an important incoming call field, a chat field, a left message field, a reminder setting field, or a query field.

Optionally, in this embodiment of the present application, as shown in FIG. 9, the execution unit 346 includes a presentation subunit 3461, where the presentation subunit 3461 is configured to present a notification message using the second terminal by means of an in-time notification when the matching field of the word text belongs to the important incoming call field.

Optionally, in this embodiment of the present application, as shown in FIG. 9, the execution unit 346 further includes a notification subunit 3462, where the notification subunit 3462 is configured to, while the presentation subunit 3461 presents the notification message using the second terminal by means of an in-time notification, instruct, by vibrating or ringing the second terminal, a user to check the notification message.

Optionally, in this embodiment of the present application, as shown in FIG. 9, the execution unit 346 includes a reply subunit 3463, where the reply subunit 3463 is configured to determine a reply text according to the matching field of the word text; perform speech synthesis on the reply text to obtain a reply speech; and send the reply speech to the first terminal.

Optionally, in this embodiment of the present application, the execution module 340 is configured to send a mail to a corresponding mailbox of the second terminal, according to the word text obtained after conversion performed by the conversion module 330, by sending a mail, or present the word text using the second terminal, where the mail carries the word text.

Optionally, in this embodiment of the present application, as shown in FIG. 9, the apparatus further includes a determining module 350, where the determining module 350 is configured to determine whether at least one of the following conditions is met: a location of the second terminal belongs to a pre-determined area; a set mode of the second terminal is a silent mode; a set mode of the second terminal is an outdoor mode; a time when the call request is made falls within a pre-determined time; a requester of the call request is in a preset address book; a quantity of times that the requester of the call request makes a call within a pre-determined time range reaches a pre-determined quantity of times; or call duration of the call request meets pre-determined duration; and the sending module 320 is configured to send the call response to the first terminal when the determining module 350 determines that at least one of the foregoing conditions is met.

Optionally, in this embodiment of the present application, as shown in FIG. 9, the apparatus further includes a presentation module 360, where the presentation module 360 is configured to present a configuration interface using a display device of the second terminal, where the configuration interface is used by a user to enter configuration information, and the configuration information is configuration information used to implement a voice mailbox function.

Optionally, in this embodiment of the present application, as shown in FIG. 9, the apparatus further includes an acquiring module 370, where the acquiring module 370 is configured to acquire the configuration information entered by the user.

Optionally, in this embodiment of the present application, as shown in FIG. 9, the apparatus 300 further includes a recording module 380 and a storage module 390, where the recording module 380 is configured to record the voice message received by the receiving module 310, to acquire a recorded file; and the storage module 390 is configured to store the recorded file recorded by the recording module 380, to help a user of the second terminal check the recorded file.

Optionally, in this embodiment of the present application, the apparatus 300 is the second terminal or a server in the Internet.

It should be understood that, in this embodiment of the present application, the apparatus 300 may correspond to the second terminal or the server in the Internet in the method 100, and is capable of implementing a corresponding function of the second terminal or the server in the Internet. For brevity, details are not described repeatedly herein. Alternatively, the apparatus 300 may correspond to the terminal A in the method 200, and is capable of implementing a corresponding function of the terminal A. For brevity, details are not described repeatedly herein.

Therefore, in this embodiment of the present application, after a voice message sent by a first terminal to a second terminal is received, the voice message is converted into a word text, and a reply operation with respect to the first terminal or a notification operation with respect to the second terminal is performed according the word text. Because the voice message is converted into the word text and the word text is easier to process, more functions can be implemented, or the word text can enable a user to acquire call content by means of viewing. Therefore, this embodiment of the present application makes the reply operation with respect to the first terminal or the notification operation with respect to the second terminal more flexible and more intelligent, and therefore makes a function of a voice mailbox stronger and more intelligent. A matching field of the word text is determined by means of NLP, and the reply operation with respect to the first terminal or the notification operation with respect to the second terminal is performed based on the matching field of the word text, so that the reply operation or the notification operation is more target-oriented. For example, when the matching field of the word text is an important incoming call field, the user may be notified in time, and when the matching field of the word text does not belong to the important incoming call field, the user may be notified based on a non-user-disturbing principle, thereby making a function of the voice mailbox stronger and more intelligent. In addition, the voice mailbox may be enabled when a scenario that the terminal is in meets a pre-determined scenario, where the pre-determined scenario may be configured by the user. For example, the voice mailbox is enabled when a location of the terminal belongs to a pre-determined area or a call request meets a pre-determined condition, so that the voice mailbox may be enabled when it is not convenient for the user to answer the call or when the user cannot answer the call, thereby making a function of the voice mailbox stronger and more intelligent.

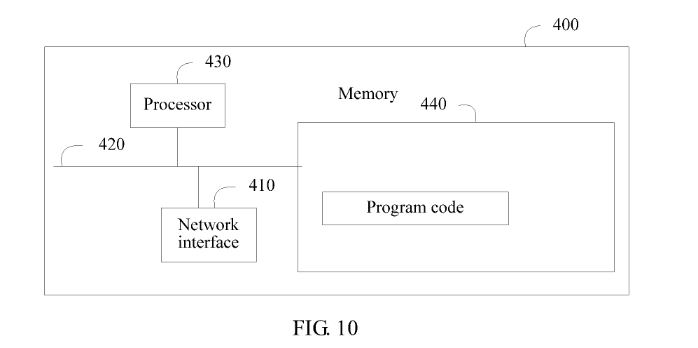

FIG. 10 is a schematic block diagram of an apparatus 400 for implementing a voice mailbox according to an embodiment of the present application. As shown in FIG. 10, the apparatus 400 includes a network interface 410, a bus 420, a processor 430, and a memory 440. The network interface 410 is configured to implement a communication connection to at least one other network element, the bus 420 is configured for communication connections between internal elements of the apparatus 400, and the memory 440 is configured to store program code. The program code stored in the memory 440 may form an independently running thread, or may form an event-triggered program waked using a notification mechanism.

The processor 430 is configured to invoke the program code stored in the memory 440, to perform the following operations: receiving, using the network interface 410, a call request that is from a first terminal and whose destination address is a second terminal; sending a call response to the first terminal using the network interface 410 based on the call request, where the call response is used to instruct a user of the first terminal to leave a voice message; receiving, using the network interface 410, a voice message that is sent by the first terminal after the call response is received; recognizing words in the voice message, to convert the voice message into a word text; and performing, according to the word text, a reply operation with respect to the first terminal or a notification operation with respect to the second terminal.

Optionally, in this embodiment of the present application, the processor 430 is configured to invoke the program code stored in the memory 440, to perform the following operations: performing NLP on the word text, to determine a matching field of the word text; and performing, according to the matching field of the word text, the reply operation with respect to the first terminal or the notification operation with respect to the second terminal.

Optionally, in this embodiment of the present application, the processor 430 is configured to invoke the program code stored in the memory 440, to perform the following operation: performing word matching for the word text according to field term bases of M fields, to determine a matching field of the word text from the M fields, where M is greater than or equal to 1.

Optionally, in this embodiment of the present application, the processor 430 is configured to invoke the program code stored in the memory 440, to perform the following operations: performing word segmentation on the word text according to field term bases of M fields, to obtain a word segmentation result corresponding to at least one field, where M is greater than or equal to 1 and the at least one field belongs to the M fields; and performing, according to a field model of each field of the at least one field, matching for the word segmentation result corresponding to the at least one field, to determine a matching field of the word text from the at least one field.

Optionally, in this embodiment of the present application, a field corresponding to NLP includes at least one of an important incoming call field, a chat field, a left message field, a reminder setting field, or a query field.

Optionally, in this embodiment of the present application, the processor 430 is configured to invoke the program code stored in the memory 440, to perform the following operation: presenting a notification message using the second terminal by means of an in-time notification when the matching field of the word text belongs to the important incoming call field.

Optionally, in this embodiment of the present application, the processor 430 is configured to invoke the program code stored in the memory 440, to perform the following operation: while the notification message is presented using the second terminal by means of an in-time notification, instructing, by vibrating or ringing the second terminal, a user to check the notification message.

Optionally, in this embodiment of the present application, the processor 430 is configured to invoke the program code stored in the memory 440, to perform the following operations: determining a reply text according to the matching field of the word text; performing speech synthesis on the reply text to obtain a reply speech; and sending the reply speech to the first terminal using the network interface 410.

Optionally, in this embodiment of the present application, the processor 430 is configured to invoke the program code stored in the memory 440, to perform the following operation: sending a mail to a corresponding mailbox of the second terminal according to the word text using the network interface 410 by sending a mail, or presenting the word text using the second terminal, where the mail carries the word text.

Optionally, in this embodiment of the present application, the processor 430 is configured to invoke the program code stored in the memory 440, to perform the following operation: sending the call response to the first terminal when it is determined that at least one condition of the following conditions is met: a location of the second terminal belongs to a pre-determined area; a set mode of the second terminal is a silent mode; a set mode of the second terminal is an outdoor mode; a time when the call request is made falls within a pre-determined time; a requester of the call request is in a preset address book; a quantity of times that the requester of the call request makes a call within a pre-determined time range reaches a pre-determined quantity of times; or call duration of the call request meets pre-determined duration.

Optionally, in this embodiment of the present application, the processor 430 is configured to invoke the program code stored in the memory 440, to further perform the following operation: presenting a configuration interface using a display device of the second terminal, where the configuration interface is used by a user to enter configuration information, and the configuration information is configuration information used to implement a voice mailbox function.

Optionally, in this embodiment of the present application, the processor 430 is configured to invoke the program code stored in the memory 440, to further perform the following operations: recording the voice message to acquire a recorded file; and storing the recorded file to help a user of the second terminal check the recorded file.

Optionally, in this embodiment of the present application, the apparatus 400 is the second terminal or a server in the Internet.

It should be understood that, in this embodiment of the present application, the apparatus 400 may correspond to the second terminal or the server in the Internet in the method 100, and is capable of implementing a corresponding function of the second terminal or the server in the Internet. For brevity, details are not described repeatedly herein. Alternatively, the apparatus 400 may correspond to the terminal A in the method 200, and is capable of implementing a corresponding function of the terminal A. For brevity, details are not described repeatedly herein.

Therefore, in this embodiment of the present application, after a voice message sent by a first terminal to a second terminal is received, the voice message is converted into a word text, and a reply operation with respect to the first terminal or a notification operation with respect to the second terminal is performed according the word text. Because the voice message is converted into the word text and the word text is easier to process, more functions can be implemented, or the word text can enable a user to acquire call content by means of viewing. Therefore, this embodiment of the present application makes the reply operation with respect to the first terminal or the notification operation with respect to the second terminal more flexible and more intelligent, and therefore makes a function of a voice mailbox stronger and more intelligent. A matching field of the word text is determined by means of NLP, and the reply operation with respect to the first terminal or the notification operation with respect to the second terminal is performed based on the matching field of the word text, so that the reply operation or the notification operation is more target-oriented. For example, when the matching field of the word text is an important incoming call field, the user may be notified in time, and when the matching field of the word text does not belong to the important incoming call field, the user may be notified based on a non-user-disturbing principle, thereby making a function of the voice mailbox stronger and more intelligent. In addition, the voice mailbox may be enabled when a scenario that the terminal is in meets a pre-determined scenario, where the pre-determined scenario may be configured by the user. For example, the voice mailbox is enabled when a location of the terminal belongs to a pre-determined area or a call request meets a pre-determined condition, so that the voice mailbox may be enabled when it is not convenient for the user to answer the call or when the user cannot answer the call, thereby making a function of the voice mailbox stronger and more intelligent.

A person of ordinary skill in the art may be aware that, the exemplary units and algorithm steps described with reference to the embodiments disclosed in this specification may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present application.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiments are merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented using some interfaces. The indirect couplings or communication connections between the apparatuses or units may be implemented in electronic, mechanical, or other forms.

The units, subunits, and/or modules described as separate parts may or may not be physically separate, and parts displayed as units, subunits, and/or modules may or may not be physical units, and may be located in one position, or may be distributed on a plurality of network units. Some or all of the units may be selected according to actual needs to achieve the objectives of the solutions of the embodiments.

In addition, function units, subunits, and/or modules in the embodiments of the present application may be integrated into one processing unit, or each of the units, subunits, and/or modules may exist alone physically, or two or more units are integrated into one unit.

When the functions are implemented in the form of a software functional unit and sold or used as an independent product, the functions may be stored in a computer-readable storage medium. Based on such an understanding, the technical solutions of the present application essentially, or the part contributing to the prior art, or some of the technical solutions may be implemented in a form of a software product. The software product is stored in a storage medium, and includes several instructions for instructing a computer device (which may be a personal computer, a server, or a network device) to perform all or some of the steps of the methods described in the embodiments of the present application. The foregoing storage medium includes any medium that can store program code, such as a universal serial bus (USB) flash drive, a portable hard drive, a read-only memory (ROM), a random access memory (RAM), a magnetic disk, or an optical disc.

The foregoing descriptions are merely specific implementation manners of the present application, but are not intended to limit the protection scope of the present application. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A method for implementing a voice mailbox, comprising:
receiving a call request from a first terminal and whose destination address is a second terminal;
sending a call response to the first terminal based on the call request, wherein the call response instructs a user of the first terminal to leave a voice message;
receiving a voice message sent by the first terminal after the call response is received;
converting the voice message into a word text; and
performing, according to the word text, a reply operation with respect to the first terminal or a notification operation with respect to the second terminal.

2. The method according to claim 1, wherein performing, according to the word text, the reply operation with respect to the first terminal or the notification operation with respect to the second terminal comprises:
performing natural language processing (NLP) on the word text in order to determine a matching field of the word text; and
performing, according to the matching field of the word text, the reply operation with respect to the first terminal or the notification operation with respect to the second terminal.

3. The method according to claim 2, wherein performing NLP on the word text in order to determine the matching field of the word text comprises performing word matching for the word text according to field term bases of M fields in order to determine the matching field of the word text from the M fields, wherein M is greater than or equal to 1.

4. The method according to claim 2, wherein performing NLP on the word text in order to determine the matching field of the word text comprises:
performing word segmentation on the word text according to field term bases of M fields to obtain a word segmentation result corresponding to at least one field, wherein M is greater than or equal to 1 and the at least one field belongs to the M fields; and
performing, according to a field model of each field of the at least one field, matching for the word segmentation result corresponding to the at least one field, to determine the matching field of the word text from the at least one field.

5. The method according to claim 2, wherein a field corresponding to NLP comprises at least one of an important incoming call field, a chat field, a left message field, a reminder setting field, or a query field.

6. The method according to claim 5, wherein performing, according to the matching field of the word text, the reply operation with respect to the first terminal or the notification operation with respect to the second terminal comprises presenting a notification message using the second terminal by means of an in-time notification when the matching field of the word text belongs to the important incoming call field.

7. The method according to claim 6, wherein when the matching field of the word text belongs to the important incoming call field, performing the reply operation with respect to the first terminal or the notification operation with respect to the second terminal comprises instructing, by vibrating or ringing the second terminal, a user to check the notification message while the notification message is presented using the second terminal by means of an in-time notification.

8. The method according to claim 2, wherein performing, according to the matching field of the word text, the reply operation with respect to the first terminal or the notification operation with respect to the second terminal comprises:
obtaining a reply text according to the matching field of the word text;
performing speech synthesis on the reply text to obtain a reply speech; and
sending the reply speech to the first terminal.

9. The method according to claim 1, wherein performing, according to the word text, the reply operation with respect to the first terminal or the notification operation with respect to the second terminal comprises:
sending a mail to a corresponding mailbox of the second terminal according to the word text by sending a mail, wherein the mail carries the word text; or
presenting the word text using the second terminal.

10. The method according to claim 1, wherein sending the call response to the first terminal comprises sending the call response to the first terminal when it is determined that at least one condition of the following conditions is met:
a location of the second terminal belongs to a pre-determined area;
a set mode of the second terminal is a silent mode;
a set mode of the second terminal is an outdoor mode;
a time when the call request is made falls within a pre-determined time;
a requester of the call request is in a preset address book;
a quantity of times that the requester of the call request makes a call within a pre-determined time range reaches a pre-determined quantity of times; or
call duration of the call request meets pre-determined duration.

11. The method according to claim 1, wherein the method further comprises presenting a configuration interface using a display device of the second terminal, wherein the configuration interface is used by a user to enter configuration information, and wherein the configuration information is configuration information used to implement a voice mailbox function.

12. The method according to claim 1, further comprising:
recording the voice message to acquire a recorded file; and
storing the recorded file to help a user of the second terminal check the recorded file.

13. An apparatus for implementing a voice mailbox, comprising:
a receiver configured to receive a call request that is from a first terminal and whose destination address is a second terminal;
a transmitter configured to send a call response to the first terminal based on the call request received by the receiver, wherein the call response is used to instruct a user of the first terminal to leave a voice message,
wherein the receiver is configured to receive a voice message that is sent by the first terminal after the call response is received;
a processor configured to:
convert the voice message into a word text; and
perform, according to the word text obtained after conversion, a reply operation with respect to the first terminal or a notification operation with respect to the second terminal.

14. The apparatus according to claim 13, wherein the processor is configured to:
perform natural language processing (NLP) on the word text obtained after conversion in order to obtain a matching field of the word text; and
perform, according to the matching field the reply operation with respect to the first terminal or the notification operation with respect to the second terminal.

15. The apparatus according to claim 14, wherein the processor is further configured to perform word matching for the word text according to field term bases of M fields in order to obtain the matching field of the word text from the M fields, wherein M is greater than or equal to 1.

16. The apparatus according to claim 14, wherein the processor is further configured to:
perform, according to field term bases of M fields, word segmentation on the word text obtained after conversion in order to obtain a word segmentation result corresponding to at least one field, wherein M is greater than or equal to 1 and the at least one field belongs to the M fields; and
perform, according to a field model of each field of the at least one field, matching for the word segmentation result that corresponds to the at least one field in order to obtain the matching field of the word text from the at least one field.

17. The apparatus according to claim 14, wherein a field corresponding to NLP comprises at least one of an important incoming call field, a chat field, a left message field, a reminder setting field, or a query field.

18. The apparatus according to claim 17, wherein the processor is further configured to present a notification message using the second terminal by means of an in-time notification when the matching field of the word text belongs to the important incoming call field.

19. The apparatus according to claim 18, wherein the processor is further configured to instruct, by vibrating or ringing the second terminal, a user to check the notification message while presenting the notification message using the second terminal by means of an in-time notification.

20. The apparatus according to claim 14, wherein the processor is further configured to:
obtain a reply text according to the matching field of the word text;
perform speech synthesis on the reply text to obtain a reply speech; and
send the reply speech to the first terminal.
